(19) United States
(12) Patent Application Publication
(10) Pub. No.: US 2010/0230558 A1
(43) Pub. Date: Sep. 16, 2010

(54) IV POLE FOR FIELD USE

(76) Inventor: David Kirkwood Knubley, Comox (CA)

Correspondence Address: David Knubley, 1723 Knight Rd., Comox, BC, V9M 4A2, CA

(21) Appl. No.: 12/402,746

(22) Filed: Mar. 12, 2009

(51) Int. Cl. F16M 13/00; F16M 11/00

(52) U.S. Cl. 248/125.8; 248/121

(57) ABSTRACT

This invention is directed to a pole for supporting an intravenous bag for use in the field on uneven or soft terrain. The pole has a pointed tip which may be pressed into soft ground, mud, tundra or ice. The pole is inexpensive to make, collapsible for storage and may be easily transported.

### FIELD OF THE INVENTION

This invention is directed to a pole for supporting an intravenous bag for use in the field. The pole is suitable for use on uneven ground and on ground which is too soft to support other types of IV pole. The IV pole is collapsible for storage and may be easily transported.

### BACKGROUND TO THE INVENTION

Poles for supporting intravenous bags (“IV poles”) are well known. Many of these are constructed so that the pole may be collapsed (for example, U.S. Pat. Nos. 4,744,536 [Bancalari, May 17, 1988], 4,807,837 [Gawlik et al. Feb. 28, 1989], 4,892,279 [Lafferty et al. Jan. 9, 1990], 6,969,031 [Ugent et al. Nov. 29, 2005], 6,983,915 [Adelman Jan. 10, 2006] and 7,281,691 [Adelman Oct. 16, 2007]). Making a collapsible pole is important as the pole's smaller size makes it easier for carrying by military and emergency services personnel. Frequently the poles are made of a number of segments which are connected together by hinges or which telescope together. In use, the segments are held rigid by a locking mechanism.

Commonly, the pole has a bag support member on which a variety of bags may be hung. This can be a hook or hanger constructed to hold the bag away from the pole so that the bag is not squeezed or distorted. In use, such poles are designed to hold a bag approximately 2 to 3 feet vertically from the patient so that gravity will provide an appropriate amount of pressure to deliver the fluids to the patient.

At the base of the pole, structure is provided to give the pole lateral stability. Usually, three legs are arranged as a tripod, though more legs can be employed. The legs are often terminated with wheels for rolling on floors.

Although, there are many IV poles in use, none are well-suited to use on uneven or soft ground such as is frequently found on the battlefield or at the scene of emergencies. There is a need for an IV pole which can be used in soil, snow, ice, bog, mud, tundra or sand.

Further, many IV poles are complex in structure making them less reliable, less easy to erect in the field and more expensive to manufacture.

### SUMMARY OF THE INVENTION

The invention is an IV pole, suitable for insertion into soft terrain. The IV pole has a bag support member, a pole and a pole support member with a pointed tip. In use, the bag support member is attached to the upper end of the pole, the pole support member is attached to the lower end of the pole and the pole is held erect by pushing the pointed tip into the terrain. The invention employs commonly available components, arranged in a novel manner.

In the preferred embodiment, the IV pole has a pole made up of interlocking sections. When the interlocking sections are disassembled, the IV pole can be collapsed to a compact form more suitable for transport. The interlocking sections are tubular and are formed with one male end and one female end. The pole is assembled by inserting the male ends into the adjacent female ends. The female end of the uppermost of the interlocking sections is inserted into a matching recess in the bag support member. An elastic cord runs through a passage which passes through the bag support member and the interlocking sections. The elastic cord is under tension and is held in place by two knots at either end of the passage.

In an alternative embodiment, the interlocking sections are arranged so that the uppermost section has a male end which is inserted in the bag support member.

A number of alternative embodiments are presented herein, each presenting a variation in the shape of the pole support member or the means by which the pole support member is attached to the pole.

In an alternative embodiment, the invention comprises just the bag support member and a pole. There is no separate piece for the pole support member; the lower end of the pole is simply cut at an angle to make a point.

### BRIEF DESCRIPTION OF THE DRAWINGS

FIG. 1 is a perspective drawing of the preferred embodiment of the invention as employed in the field.

FIG. 2 is a cross-section of the preferred embodiment of the invention in its folded configuration.

FIG. 3 is an enlarged cross-section of the bag support member of the preferred embodiment of the invention.

FIGS. 4A to 4E are cross-sections of the lower portion of the invention showing the pole support member of the preferred embodiment and of 4 alternative embodiments of the invention.

FIG. 4F shows a cross-section of the lower end of the pole where the IV pole has no pole support member.

FIG. 5 shows the lower part of the pole in cross-section using an alternative arrangement for tying off the elastic cord.

FIG. 6 shows a perspective drawing of an embodiment of the invention using telescoping pole segments.

FIG. 7 is a cross-section of the IV pole having pole sections with their narrowed necks upper most.

### DETAILED DESCRIPTION

The subject matter of this application is a pole 100 for supporting a bag of fluids for use as a medical drip feed in the field. The subject-matter is comprised of commonly available parts assembled in a manner that is claimed to be inventive.

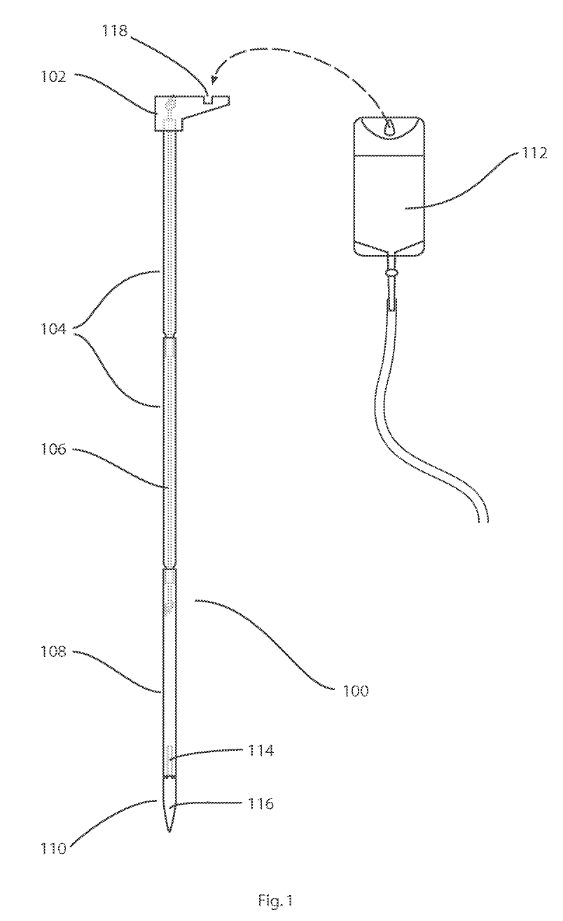

FIG. 1 shows a perspective drawing of the preferred embodiment of the invention. The pole 100 is assembled from a terminal section 108 and other support sections 104. (In FIG. 1, there are two support sections 104 shown.) When assembled, the terminal section 108 and the support sections 104 are connected together to form a rigid pole drawn together by an elastic cord 106 running through a central channel throughout the length of the pole. A bag support member 102 is attached to the pole over the upper end of the topmost support section 104. A pole support member 110 has a plug 114 and a head 116. The pole support member 110 is attached to the lower end of the terminal section 108 of the pole with the plug 114 being pushed into the central channel within the lower end of the terminal section 108. The pole support member 110 remains in place by the friction between the plug 114 and the wall of the central channel.

In use, pole 100 is pushed into the ground and an intravenous bag 112 is hung from a notch 118 in the bag support member 102. The pole can be made in a variety of lengths by using more (or fewer) support sections 104 or by making the support sections 104 longer (or shorter). In one configuration, the pole can be made with just the terminal section 108 and no support sections, though such a pole is no longer collapsible. Typically the pole is between 36 and 48 inches long so that the bag support member 102 is 24 to 36 inches above the patient.

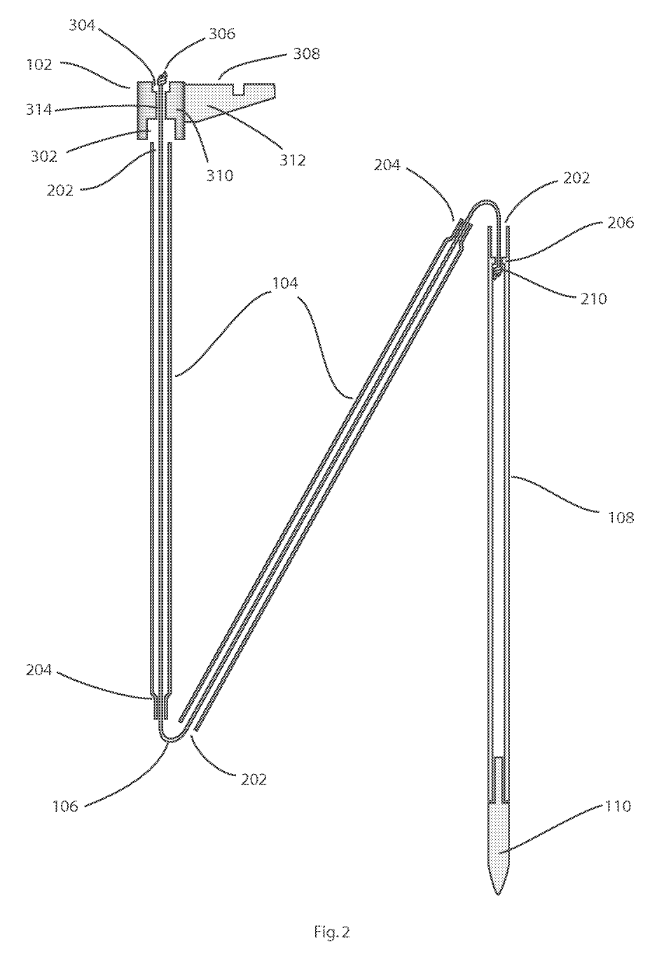

FIG. 2 shows the preferred embodiment of the invention in cross-section. This figure shows the IV pole in its folded, compact configuration. The support sections 104 are each made from a tube with a narrowed region 204 at the lower end. The narrowed region 204 is sized so as to fit within the channel opening 202 at the upper end of an adjacent, connecting support section 104 or of the terminal section 108. The channel within each support section 104 is large enough to allow the unimpeded movement of the elastic cord 106. The terminal section 108 is made from a tube of the same diameter as the support sections 104 but having a narrowed neck 206 near the upper end of the terminal section 108.

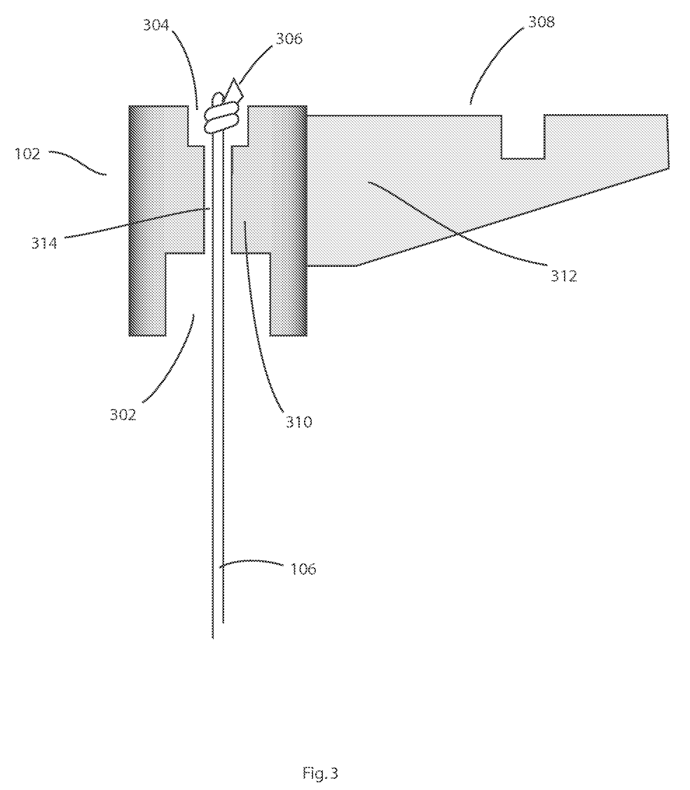

The bag support hanger 102 is shown at a larger size in FIG. 3. The bag support hanger 102 is a single piece, comprising two portions—a cap portion 310 and a hanger portion 312. The cap portion 310 is approximately cylindrical with an upper recess 304 and a lower recess 302. The upper recess 304 is cylindrical and sized to hold a knot 306 made on the upper end of the elastic cord 106. The lower recess 302 is sized to allow the upper end of the pole, 104 or 108, to slide snugly into the lower recess 302 of the cap portion 310. A cylindrical channel 314 extends from the upper recess 304 to the lower recess 302 and is sized to allow the elastic cord 106, but not the knot 306, to pass freely through.

With reference to FIG. 2, the elastic cord 106 passes from the upper recess 304 through the cylindrical channel 314, through the central channel within the support sections 104 and through a narrowed neck 206 within the upper portion of the terminal section 108. The elastic cord 106 is stretched under tension and is kept in place by knots 306 and 210, tied so as to be too large to slip through the cylindrical channel 314 of the cap portion 310 or the narrowed neck 206 of the terminal section 108.

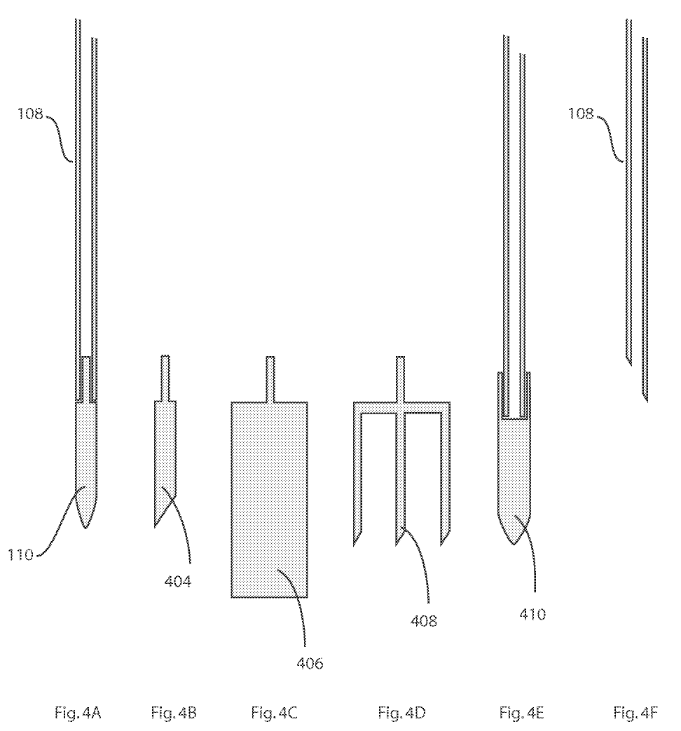

When the pole 100 is not in use, it may be folded to a smaller length by separating the support sections 104 and the terminal section 108 much as is commonly done with camping tent poles. FIG. 4A to 4D show the pole support member 110 of four alternative embodiments of theinvention—all of which are installed as plugs in the terminal section 108. FIG. 4A shows a rounded point symmetrical about the vertical axis; FIG. 4B shows a cylinder sliced by a plane 404; FIG. 4C shows a spade 406; and FIG. 4D shows a fork with three tines 408.

FIG. 4E shows an alternative embodiment of the invention wherein the lower end of the terminal section 108 is plugged into a recess in the pole support member 410.

FIGS. 4A to 4E show some alternative embodiments each employing a variety of pole support member. It is expected that the invention can be constructed with other variants for the pole support member 110 of the invention.

FIG. 4F shows an alternative embodiment of the invention in which the IV pole has no pole support member 110 at all. The lower end of the terminal section 108 is simply cut at an acute angle. The cut lower end is either left open or closed by squeezing the sides together with pliers or a vice.

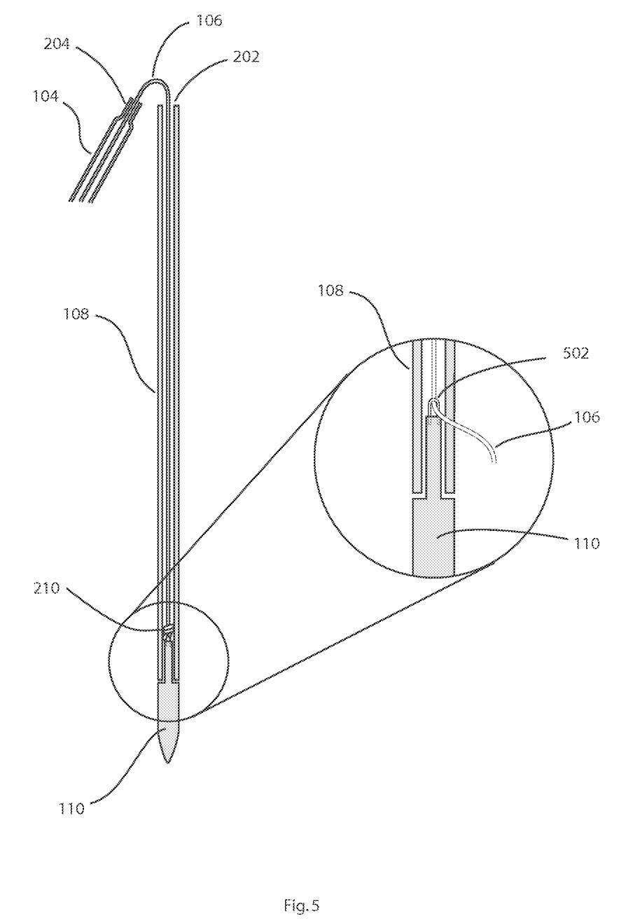

As is shown in FIG. 5, in a further embodiment of the invention, the terminal section 108 is replaced by a hollow tube of the same diameter as a support section 104 and the cord 106 is tied to a ring 502 protruding from the pole support member 110 towards the interior of the lower end of the terminal section 108. FIG. 5 includes an exploded view of the region where the elastic cord 106 is to be tied to the pole support member 110.

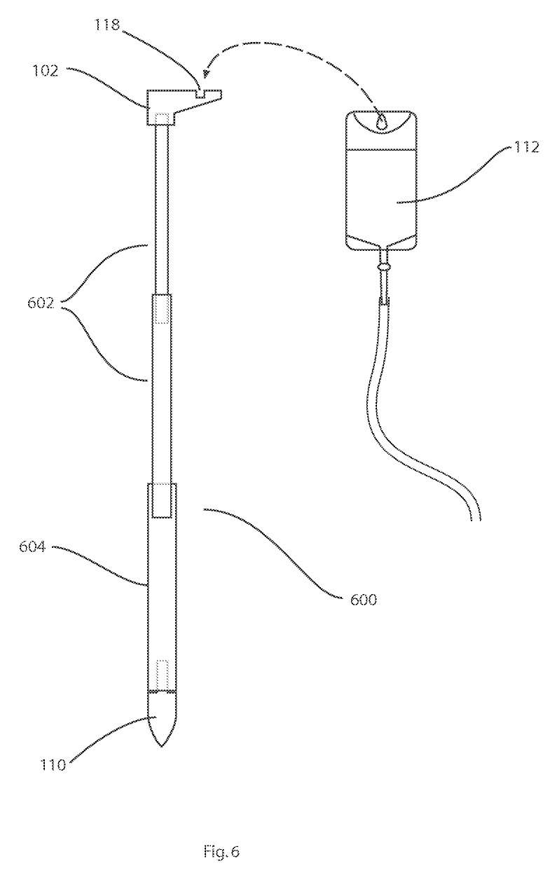

With reference to FIG. 6, a further embodiment of the invention uses a pole 600 made of a plurality of telescoping sections 602 and 604. The sections 602 are held in place by one of a variety of well-known means. Where the telescoping sections 602 are held in place by a locking clutch or a split collar and thumb screw, the height of the pole may be varied. Where the telescoping sections 602 are held in place by a spring button locking into a variety of holes in the telescoping sections, the pole may be conveniently adjusted to one of a selection of predetermined heights.

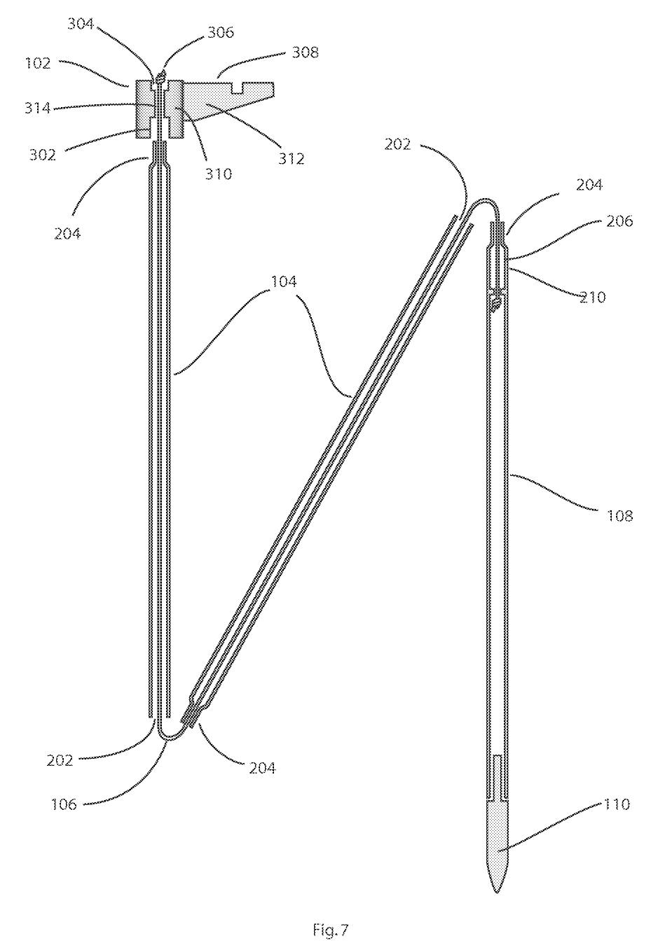

FIG. 7 shows an alternative embodiment of the invention in which the terminal section 108 has a narrowed region 204 at its upper end, the support sections 104 are reversed each having a narrowed region 204 at the upper end and a channel opening 202 at the lower end and the lower recess 302 in the bag support member 102 is cylindrical and is made slightly larger than the narrowed region 204 at the upper end of the pole.

It is advantageous for the terminal section and the support sections to be made of a strong material having some flexibility. Suitable materials have been found to be metal (particularly light alloys containing aluminum or magnesium), fibreglass, composites (such as carbon fibre), wood or various semi-rigid plastics. Similarly, the bag support member 102 and the pole support member 110 can be made from a wide variety of rigid materials.

The IV pole is made from simple, offthe shelf components which allow the IV pole to be lightweight and cheap to produce.

What is claimed is:

1. An IV pole, suitable for insertion into soft terrain, comprising a bag support member, a pole and a pole support member, said pole having a lower end and an upper end, wherein the pole support member is attached to the lower end of the pole and the bag support member is attached to the upper end of the pole, the pole support member having a pointed tip.

2. The IV pole of claim 1 wherein the pole is comprised of interlocking sections, said sections being separable so that the IV pole can be collapsed to a smaller length.

3. The IV pole of claim 2 wherein:
(a) the interlocking sections comprise a terminal section and zero or more support sections;
(b) the terminal section, the support sections and the bag support member each have an upper end and a lower end;
(c) the terminal section and the support sections are tubular having a central channel passing from the upper end to the lower end of each section;
(d) the terminal section has:
a cylindrical recess at its upper end; and
a narrowed neck below the recess, said narrowed neck having a passage therethrough connecting the upper and lower ends of the terminal section;
(e) each support section comprises:
a cylindrical female region at the upper end wherein the interior diameter of said female region is the same as the internal diameter of the recess in the terminal section; and
a cylindrical male region at the lower end wherein the exterior diameter of the male region is slightly less than the interior diameter of the recess in the terminal section.
(f) the bag support member has:
a passage connecting its upper and lower ends; and
a cylindrical recess at its lower end, said recess having an interior diameter slightly larger than the exterior diameter of the upper end of the terminal section;
(g) the male region of each support section save the lowermost is inserted into the female region of the next inferior support section;
(h) the male region of the lowermost support section is inserted into the cylindrical recess of the terminal section;
(i) the male region of the uppermost of the support sections or the male region of the terminal section if there are no support sections is inserted into the recess in the bag support member; and
(j) an elastic cord is threaded through the passage in the bag support member, through the central channel of the support sections and through the narrowed neck of the terminal section, said elastic cord being stretched and held in place by two knots, one knot being above the upper end of the bag support member and the other knot being below the narrowed neck of the terminal section.

4. The IV pole of claim 2 wherein:
(a) the interlocking sections comprise a terminal section and zero or more support sections;
(b) the terminal section, the support sections and the bag support member each have an upper end and a lower end;
(c) the bag support member has:
a passage connecting its upper and lower ends; and
a cylindrical recess at its lower end.
(d) the terminal section and the support sections are tubular having a central channel passing from the upper end to the lower end of each section;
(e) each support section comprises:
a cylindrical male region at the upper end; and
a cylindrical female region at the lower end wherein the interior diameter of the female region is the same as the interior diameter of the recess in the bag support member;
(f) the terminal section has:
a cylindrical male region at its upper end; and
a narrowed neck below the male region, said narrowed neck having a passage therethrough connecting the upper and lower ends of the terminal section;
(g) the exterior diameter of the cylindrical male regions of the support sections and the terminal section is slightly less than the interior diameter of the recess in the bag support member
(h) the male region of the terminal section and of each support section save the uppermost is inserted into the female region of the next superior support section;
(i) the male region of the uppermost support section or the male region of the terminal section, if there are no support sections, is inserted into the cylindrical recess of the bag support member; and
(j) an elastic cord is threaded through the passage in the bag support member, through the central channel of the support sections and through the narrowed neck of the terminal section, said elastic cord being stretched and held in place by two knots, one knot being above the upper end of the bag support member and the other knot being below the narrowed neck of the terminal section.

5. The IV pole of claim 1 wherein:
(a) the pole support member has a plug and a head; and
(b) the pole support member is attached to the pole by inserting the plug into the lower end of the pole.

6. The IV pole of claim 5 wherein the head is radially symmetric, tapering in cross-section from a circle, of diameter matching the exterior diameter of the lower end of the terminal section, to a sharp point.

7. The IV pole of claim 5 wherein the head is shaped as a cylinder sliced by a plane.

8. The IV pole of claim 5 wherein the head is a thin rectilinear solid.

9. The IV pole of claim 5 wherein the head is shaped as a fork with two or more tines.

10. The IV pole of claim 5 wherein the elastic cord is fastened to the pole support member by tying the elastic cord to a ring protruding from the plug into the interior of the central channel of the terminal section.

11. The IV pole of claim 1 wherein:
(a) the pole support member has an upper surface and a head;
(b) the upper surface has a cylindrical recess with diameter slightly larger than the external diameter of the lower end of the pole; and
(c) the lower end of the pole is inserted into the cylindrical recess of the pole support member.

12. The IV pole of claim 11 wherein the head is radially symmetric, tapering in cross-section from a circle, of diameter matching the exterior diameter of the lower end of the terminal section, to a sharp point.

13. The IV pole of claim 11 wherein the head is shaped as a cylinder sliced by a plane.

14. The IV pole of claim 11 wherein the head is a thin rectilinear solid.

15. The IV pole of claim 11 wherein the head is shaped as a fork with two or more tines.

16. The IV pole of claim 11 wherein the elastic cord is fastened to the pole support member by tying the elastic cord to a ring protruding from the plug into the interior of the central channel of the terminal section.

17. An IV pole, suitable for insertion into soft terrain, comprising a bag support member and a pole, said pole having a lower end and an upper end, wherein the bag support member is attached to the upper end of the pole and the lower end of the pole is pointed.

18. The IV pole of claim 17 wherein the pole is comprised of interlocking sections, said sections being separable so that the IV pole can be collapsed to a smaller length.
